(19) United States
(12) Patent Application Publication
(10) Pub. No.: US 2026/0249844 A1
(43) Pub. Date: Aug. 27, 2026

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Takahiro Shimizu, Tokyo (JP); Sho Tamura, Tokyo (JP)

(21) Appl. No.: 19/549,150

(22) Filed: Feb. 25, 2026

(30) Foreign Application Priority Data
Feb. 26, 2025 (JP) 2025-028981

(51) Int. Cl. B60W 30/12; B60W 30/182; G06V 20/56

(52) U.S. Cl. CPC B60W 30/12; B60W 30/182; G06V 20/588; B60W 2420/403; B60W 2552/30; B60W 2552/53; B60W 2556/40

(57) ABSTRACT

A vehicle control device according to an embodiment includes a processor that executes instructions to: recognize a device marking line based on an output of a detection device, recognize a map marking line based on map information, compare the device marking line and the map marking line based on recognition results, and control the vehicle based on a comparison result, wherein when a road shape that bends to the other of the left and right after bending to one of the left and right as viewed from the vehicle exists in the travel lane in the traveling direction of the vehicle, the processor performs the comparison based on marking lines up to a point on the vehicle side from a point where bending to the other of the left and right begins.

### CROSS-REFERENCE TO RELATED APPLICATION

This application claims priority based on Japanese Patent Application No. 2025-28981 filed on February 26, 2025, the content of which is incorporated herein by reference.

### BACKGROUND

### Field of the Invention

The present invention relates to a vehicle control device, a vehicle control method, and a storage medium.

### Description of Related Art

In recent years, efforts to provide access to sustainable transportation systems that are considerate of people who are in vulnerable positions among traffic participants have been intensified. To realize this, through research and development related to automated driving technology, focus is being placed on research and development to further improve traffic safety and convenience. In relation to this, conventionally, in a first range ahead of a mobile object, it is determined whether or not a first state is present in which a first angle difference between a lane recognized by a recognition means and a lane based on map information is continuously equal to or greater than a first threshold value, and in a second range closer to the mobile object than the first range, it is determined whether or not a second state is present in which a second angle difference between the lane recognized by the recognition means and the lane based on map information is equal to or greater than a second threshold value, and in at least one of the case where it is determined to be the first state and the case where it is determined to be the second state, a technology is known that performs travel control in which the recognition result of the recognition means is prioritized over the map information (for example, Japanese Unexamined Patent Application, First Publication No. 2021-149321).

### SUMMARY

By the way, in conventional automated driving technology, in the case of a road shape having curvature and in which the manner of bending of the road changes, there have been cases where the recognition accuracy of road marking lines recognized from detection devices such as cameras has decreased. Therefore, there has been an issue that comparison with road marking lines indicated in map information may not be performed appropriately.

In order to solve the above issue, one object of the present application is to provide a vehicle control device, a vehicle control method, and a storage medium that can more appropriately perform comparison of road marking lines according to road conditions. Furthermore, this contributes to the development of sustainable transportation systems.

The vehicle control device, vehicle control method, and storage medium according to the present invention adopt the following configurations.
(1): A vehicle control device according to one aspect of the present invention includes a memory storing a instructions; and a processor configured to execute the instructions stored in the memory to: recognize, as a device marking line, a marking line that delineates a travel lane of a vehicle, based on an output of a detection device that detects a surrounding situation of the vehicle; recognize, as a map marking line, a marking line that delineates the travel lane of the vehicle from map information, based on position information of the vehicle; compare the device marking line and the map marking line based on recognition results; and control the vehicle based on a comparison result of the comparator, wherein when a road shape that bends to the other of the left and right after bending to one of the left and right as viewed from the vehicle exists in the travel lane in the traveling direction of the vehicle, the processor performs the comparison based on marking lines up to a point on the vehicle side from a point where bending to the other of the left and right begins. (2): In the aspect of (1) above, the processor performs the comparison in a range based on a comparison target distance ahead of the vehicle in the traveling direction; and shortens the comparison target distance before the point where bending to the other of the left and right begins exists within the comparison target distance from the vehicle, as the vehicle approaches the road shape.

(3): In the aspect of (2) above, the processor shortens the comparison target distance as the vehicle approaches the point where bending to the other of the left and right begins, such that the comparison target distance becomes shorter than a distance from a position of the vehicle to the point where bending to the other of the left and right begins.

(4): In the aspect of (2) above, the processor gradually returns the comparison target distance to the distance before shortening, after the vehicle passes the point where bending to the other of the left and right begins.

(5): In the aspect of (1) above, the road shape is a road shape in which a degree of bending of the travel lane is less than a threshold value, and which bends to the other of the left and right after bending to one of the left and right as viewed from the vehicle.

(6): In the aspect of (5) above, the processor suspends recognition of the device marking line when information of the travel lane cannot be acquired, and does not suspend recognition of the device marking line even when information of the travel lane cannot be acquired, when the vehicle travels on the road shape in which the degree of bending of the travel lane is less than the threshold value.

(7): In the aspect of (1) above, the processor detects the point where bending to the other of the left and right begins, based on a change in an extending direction of the map marking line.

(8): In the aspect of (1) above, the control of the vehicle includes driving control by a first driving mode and a second driving mode in which a degree of driving assistance is lower than the first driving mode or a task of an occupant of the vehicle is greater than the first driving mode, and the processor continues the driving control by the first driving mode when driving control by the first driving mode is being executed and a degree of divergence between the device marking line and the map marking line is less than a threshold value.

(9): In the aspect of (1) above, the processor further executes instructions to:

correct the map marking line based on the device marking line, wherein the processor performs the correction when a degree of divergence between the device marking line and the map marking line is less than a threshold value, and the processor controls the vehicle based on the corrected map marking line.

(10): In the aspect of (1) above, the control of the vehicle includes driving control by a first driving mode and a second driving mode in which a degree of driving assistance is lower than the first driving mode or a task of an occupant of the vehicle is greater than the first driving mode, and the processor switches the control of the vehicle from the first driving mode to the second driving mode when driving control by the first driving mode is being executed and a degree of divergence between the device marking line and the map marking line is equal to or greater than a threshold value.

(11): A vehicle control method according to another aspect of the present invention is a vehicle control method in which a computer recognizes, as a device marking line, a marking line that delineates a travel lane of a vehicle, based on an output of a detection device that detects a surrounding situation of the vehicle, recognizes, as a map marking line, a marking line that delineates the travel lane of the vehicle from map information, based on position information of the vehicle, compares the recognized device marking line and the map marking line, controls the vehicle based on a result of the comparison, and when a road shape that bends to the other of the left and right after bending to one of the left and right as viewed from the vehicle exists in the travel lane in the traveling direction of the vehicle, performs the comparison based on marking lines up to a point on the vehicle side from a point where bending to the other of the left and right begins.

(12): A storage medium according to another aspect of the present invention is a computer-readable non-transitory storage medium storing a program that causes a computer to recognize, as a device marking line, a marking line that delineates a travel lane of a vehicle, based on an output of a detection device that detects a surrounding situation of the vehicle, recognize, as a map marking line, a marking line that delineates the travel lane of the vehicle from map information, based on position information of the vehicle, compare the recognized device marking line and the map marking line, control the vehicle based on a result of the comparison, and when a road shape that bends to the other of the left and right after bending to one of the left and right as viewed from the vehicle exists in the travel lane in the traveling direction of the vehicle, perform the comparison based on marking lines up to a point on the vehicle side from a point where bending to the other of the left and right begins.

According to the aspects of (1) to (12) above, comparison of road marking lines can be performed more appropriately according to road conditions.

### BRIEF DESCRIPTION OF THE DRAWINGS

FIG. 1 is a configuration diagram of a vehicle system including a vehicle control device according to an embodiment.

FIG. 2 is a functional configuration diagram of a first controller and a second controller.

FIG. 3 is a diagram for explaining driving control of a vehicle according to the embodiment.

FIG. 4 is a diagram for explaining driving control in a road shape including an inflection point.

FIG. 5 is a diagram for explaining a manner of change in distance based on a distance between vehicle M and an inflection point.

FIG. 6 is a flowchart showing an example of a flow of driving control processing in the embodiment.

FIG. 7 is a flowchart showing an example of S-curve road handling processing.

### DESCRIPTION OF EMBODIMENTS

Hereinafter, embodiments of the vehicle control device, vehicle control method, and storage medium of the present invention will be described with reference to the drawings. In the following, an embodiment in which the vehicle control device is applied to an automated driving vehicle will be described. Automated driving is, for example, automatically controlling one or both of steering and speed of a vehicle to execute driving control. The above-described driving control may include, for example, various driving controls such as ACC (Adaptive Cruise Control System), LKAS (Lane Keeping Assistance System), ALC (Automated Lane Change), TJP (Traffic Jam Pilot), and CMBS (Collision Mitigation Brake System). In addition, in an automated driving vehicle, driving control by manual operation (so-called manual driving) by a user (for example, an occupant) of the vehicle may be executed. Note that the vehicle control device in the embodiment may be applied to, in addition to vehicles, mobile objects such as ships capable of moving on the ground like a hovercraft, flying objects capable of traveling on roads, and standing-ride vehicles having a power unit.

### Overall Configuration

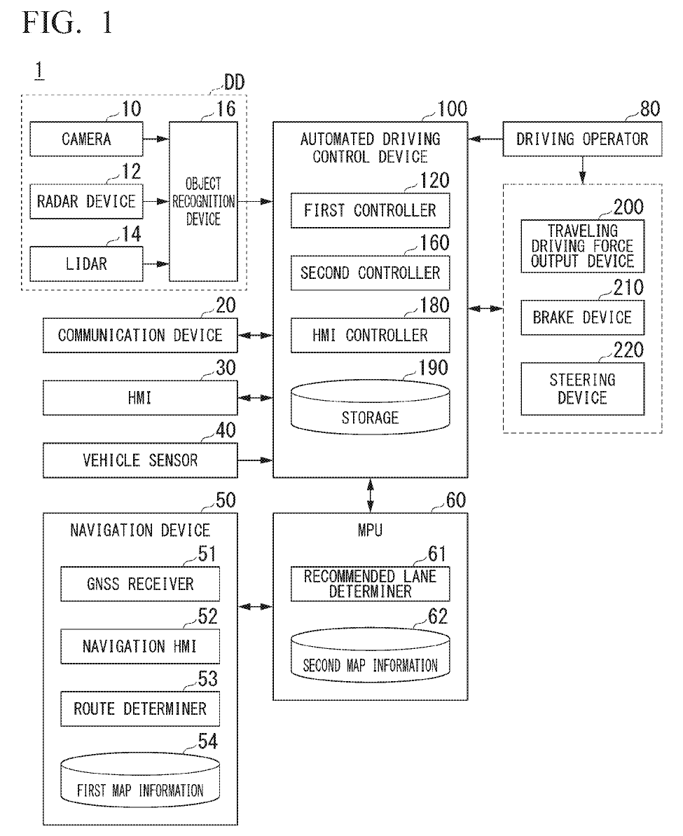

FIG. 1 is a configuration diagram of a vehicle system 1 including a vehicle control device according to the embodiment. A vehicle on which the vehicle system 1 is mounted (hereinafter referred to as vehicle M) is, for example, a two-wheeled, three-wheeled, or four-wheeled vehicle or micromobility, and its drive source is an internal combustion engine such as a diesel engine or gasoline engine, an electric motor, or a combination thereof. The electric motor operates using electric power generated by a generator connected to the internal combustion engine, or discharge electric power of a battery (storage battery) such as a secondary battery or fuel cell.

The vehicle system 1 includes, for example, a camera 10, a radar device 12, a LIDAR (Light Detection and Ranging) 14, an object recognition device 16, a communication device 20, an HMI (Human Machine Interface) 30, a vehicle sensor 40, a navigation device 50, an MPU (Map Positioning Unit) 60, a driving operator 80, an automated driving control device 100, a traveling driving force output device 200, a brake device 210, and a steering device 220. These devices and equipment are connected to each other by a multiplex communication line such as a CAN (Controller Area Network) communication line, a serial communication line, a wireless communication network, or the like. Note that the configuration shown in FIG. 1 is merely an example, and a part of the configuration may be omitted or another configuration may be added. A combination of the camera 10, the radar device 12, the LIDAR 14, and the object recognition device 16 is an example of a "detection device DD". The HMI 30 is an example of an "output device". The automated driving control device 100 is an example of a "vehicle control device".

The camera 10 is, for example, a digital camera using a solid-state imaging element such as a CCD (Charge Coupled Device) or CMOS (Complementary Metal Oxide Semiconductor). The camera 10 is attached to an arbitrary location of the vehicle M on which the vehicle system 1 is mounted. When imaging the front, the camera 10 is attached to an upper part of a front windshield, a back surface of a room mirror, a front part of a vehicle body, or the like. When imaging the rear, the camera 10 is attached to an upper part of a rear windshield, a back door, or the like. When imaging the side, the camera 10 is attached to a door mirror or the like. The camera 10, for example, periodically and repeatedly images the surroundings of the vehicle M. The camera 10 may be a stereo camera.

The radar device 12 radiates radio waves such as millimeter waves to the surroundings of the vehicle M and detects radio waves (reflected waves) reflected by surrounding objects to detect at least the position (distance and direction) of the objects. The radar device 12 is attached to an arbitrary location of the vehicle M. The radar device 12 may detect the position and speed of an object by an FM-CW (Frequency Modulated Continuous Wave) method.

The LIDAR 14 irradiates light to the surroundings of the vehicle M and measures scattered light. The LIDAR 14 detects a distance to a target based on a time from light emission to light reception. The irradiated light is, for example, pulsed laser light. The LIDAR 14 is attached to an arbitrary location of the vehicle M.

The object recognition device 16 performs sensor fusion processing on detection results by some or all of the camera 10, the radar device 12, and the LIDAR 14 included in the detection device DD to recognize the position, type, speed, and the like of objects. The object recognition device 16 outputs the recognition result to the automated driving control device 100. In addition, the object recognition device 16 may output the detection results of the camera 10, the radar device 12, and the LIDAR 14 as they are to the automated driving control device 100. In that case, the object recognition device 16 may be omitted from the configuration of the vehicle system 1 (detection device DD).

The communication device 20 communicates with, for example, other vehicles existing in the surroundings of the vehicle M, a terminal device of a user who uses the vehicle M, or various server devices, using a network such as a cellular network, a Wi-Fi network, Bluetooth (registered trademark), DSRC (Dedicated Short Range Communication), LAN (Local Area Network), WAN (Wide Area Network), or the Internet.

The HMI 30 outputs various information to occupants (including a driver) of the vehicle M and receives input operations by the occupants. The HMI 30 includes, for example, a display and a speaker. The display is, for example, an LCD (Liquid Crystal Display), an organic EL (Electro Luminescence) display device, or the like. The display displays various images (including video) in the embodiment. The display may be configured integrally with an input as a touch panel. The speaker outputs predetermined sounds (for example, alarm sounds or message sounds). In addition, the HMI 30 may be, in addition to (or instead of) the display and speaker, a microphone, a buzzer, a touch panel, a switch, a key, or the like. The switches include switches for executing or terminating predetermined driving control (for example, ACC or LKAS) that can be executed by a driving controller to be described later, switches for approving (permitting) or rejecting recommendations (proposals) for driving control from the system (vehicle system 1) side, and the like. In addition, the switches may include a switch (turn signal switch) for performing a direction indication operation, and the like.

The vehicle sensor 40 includes a vehicle speed sensor that detects the speed of the vehicle M, an acceleration sensor that detects acceleration, a yaw rate sensor that detects a yaw rate (for example, a rotational angular velocity around a vertical axis passing through the center of gravity of the vehicle M), a direction sensor that detects the direction of the vehicle M, and the like. In addition, the vehicle sensor 40 may be provided with a position sensor that detects the position of the vehicle. The position sensor is an example of a "position measurement unit". The position sensor is, for example, a sensor that acquires position information (longitude/latitude information) from a GPS (Global Positioning System) device. In addition, the position sensor may be a sensor that acquires position information using a GNSS (Global Navigation Satellite System) receiver 51 of the navigation device 50. The vehicle sensor 40 may derive the speed of the vehicle M from a difference in position information at a predetermined time (that is, distance) in the position sensor. The results detected by the vehicle sensor 40 are output to the automated driving control device 100.

The navigation device 50 includes, for example, a GNSS receiver 51, a navigation HMI 52, and a route determiner 53. The navigation device 50 holds first map information 54 in a storage device such as an HDD (Hard Disk Drive) or flash memory. The GNSS receiver 51 specifies the position of the vehicle M based on signals received from GNSS satellites. The position of the vehicle M may be specified or supplemented by an INS (Inertial Navigation System) using the output of the vehicle sensor 40. The navigation HMI 52 includes a display device, a speaker, a touch panel, keys, and the like. The GNSS receiver 51 may be provided in the vehicle sensor 40. The navigation HMI 52 may be partially or entirely shared with the HMI 30 described above. The route determiner 53, for example, determines a route (hereinafter, an on-map route) from the position of the vehicle M specified by the GNSS receiver 51 (or an arbitrary input position) to a destination input by an occupant using the navigation HMI 52, with reference to the first map information 54. The first map information 54 is, for example, information in which a road shape is expressed by links indicating roads (an example of travel paths) and nodes connected by the links. The first map information 54 may include POI (Point Of Interest) information and the like. The on-map route is output to the MPU 60. The navigation device 50 may perform route guidance using the navigation HMI 52 based on the on-map route. The navigation device 50 may transmit the current position and destination to a navigation server via the communication device 20 and acquire a route equivalent to the on-map route from the navigation server. The navigation device 50 outputs the determined on-map route to the MPU 60.

The MPU 60 includes, for example, a recommended lane determiner 61, and holds second map information 62 in a storage device such as an HDD or flash memory. The recommended lane determiner 61 divides the on-map route provided from the navigation device 50 into a plurality of blocks (for example, divides every 100 [m] with respect to the vehicle traveling direction), and determines a recommended lane for each block with reference to the second map information 62. The recommended lane determiner 61 makes a determination such as traveling in which lane from the left. When a branch point exists on the on-map route, the recommended lane determiner 61 determines the recommended lane so that the vehicle M can travel on a rational route for proceeding to the branch destination.

The second map information 62 is map information with higher precision than the first map information 54. The second map information 62 includes, for example, the number of lanes (number of travel paths), the type and shape of road marking lines (hereinafter referred to as marking lines), information on the center of lanes or information on road boundaries, and the like. The second map information 62 may include information on whether or not a road boundary is a boundary (physical boundary) including a structure through which the vehicle cannot pass (including crossing and contact). Physical boundaries are, for example, guard rails, curbs, median strips, fences, and the like. In addition, the second map information 62 may include road shape information, traffic regulation information, address information (address/postal code), facility information, parking lot information, telephone number information, and the like. Road shape information is, for example, lane width (width), gradient, branches, merges, intersections, curvature of roads (may also be referred to as radius of curvature; the same applies hereinafter), amount of change in curvature (amount of change in curvature per predetermined distance), and the like. The second map information 62 may be updated at any time by the communication device 20 communicating with an external device. The first map information 54 and the second map information 62 may be provided integrally as map information. In addition, the map information may be stored in a storage 190.

The driving operator 80 includes, for example, a steering wheel, an accelerator pedal, and a brake pedal. In addition, the driving operator 80 may include a shift lever, a non-circular steering wheel, a joystick, and other operators. An operation detector that detects, for example, an operation amount of the operator by an occupant or the presence or absence of an operation is attached to each operator of the driving operator 80. The operation detector detects, for example, a steering angle or steering torque of the steering wheel, a depression amount of the accelerator pedal or brake pedal, and the like. Then, the operation detector outputs the detection result to the automated driving control device 100, or one or both of the traveling driving force output device 200, the brake device 210, and the steering device 220.

The automated driving control device 100 executes various driving controls belonging to automated driving for the vehicle M. The automated driving control device 100 includes, for example, a first controller 120, a second controller 160, an HMI controller 180, and a storage 190. The first controller 120, the second controller 160, and the HMI controller 180 are each realized, for example, by a hardware processor such as a CPU (Central Processing Unit) executing a program (software). In addition, some or all of these components may be realized by hardware (including circuitry) such as LSI (Large Scale Integration), ASIC (Application Specific Integrated Circuit), FPGA (Field-Programmable Gate Array), GPU (Graphics Processing Unit), or SOC (System On Chip), or may be realized by cooperation of software and hardware. The above-described program may be stored in advance in a storage device (a storage device including a non-transitory storage medium) such as an HDD or flash memory of the automated driving control device 100, or may be stored in a removable storage medium such as a DVD, CD-ROM, or memory card, and installed in the storage device of the automated driving control device 100 when the storage medium (non-transitory storage medium) is attached to a drive device, card slot, or the like.

The storage 190 may be realized by the various storage devices described above, or an EEPROM (Electrically Erasable Programmable Read Only Memory), ROM (Read Only Memory), RAM (Random Access Memory), or the like. The storage 190 stores, for example, various information, programs, and the like in the embodiment. In addition, the storage 190 may store map information (for example, the first map information 54 and the second map information 62).

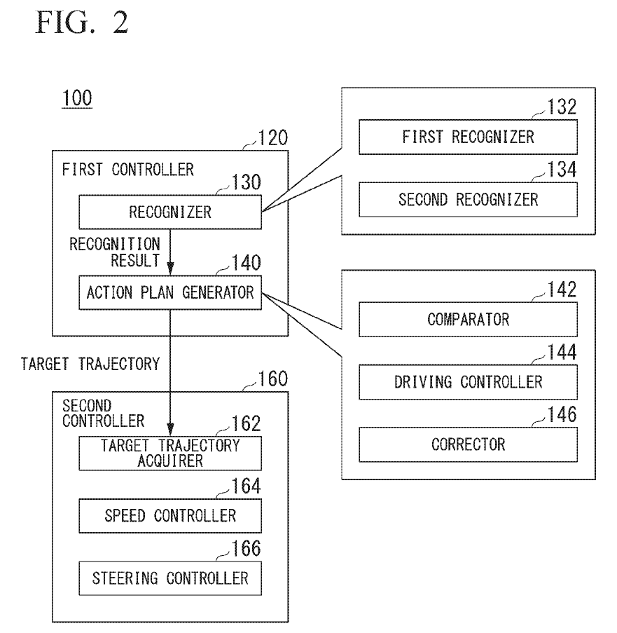

FIG. 2 is a functional configuration diagram of the first controller 120 and the second controller 160. The first controller 120 includes, for example, a recognizer 130 and an action plan generator 140. The first controller 120 realizes, for example, functions by AI (Artificial Intelligence) and functions by a model given in advance in parallel. For example, a function of "recognizing an intersection" may be realized by recognizing an intersection by deep learning or the like and recognition based on conditions given in advance (a signal, road marking, or the like that can be pattern-matched), which are executed in parallel, and both are scored and comprehensively evaluated. This ensures the reliability of automated driving. In addition, the first controller 120 executes, for example, control related to automated driving of the vehicle M based on instructions from the MPU 60, the HMI controller 180, or the like.

The recognizer 130 recognizes the surrounding situation of the vehicle M based on recognition results of the detection device DD (information input from the camera 10, the radar device 12, and the LIDAR 14 via the object recognition device 16). For example, the recognizer 130 recognizes states such as the position, speed, and acceleration of objects existing in the surroundings (within a predetermined distance) of the vehicle M. Objects include traffic participants such as other vehicles, pedestrians, and bicycles, and physical boundaries that divide roads (travel paths). The position of an object is recognized, for example, as a position on absolute coordinates with a representative point (center of gravity, drive shaft center, or the like) of the vehicle M as the origin, and is used for control. The position of an object may be represented by a representative point such as the center of gravity or corner of the object, or may be represented by an expressed region. The "state" of an object may include, for example, when the object is a mobile object such as another vehicle, the acceleration or jerk of the mobile object, or an "action state" (for example, whether or not another vehicle is changing lanes or is about to change lanes).

In addition, the recognizer 130 recognizes, for example, stop lines, obstacles, red lights, toll gates, other road events, markings (speed limit) marked on roads, and road signs marked with speed limits. In addition, the recognizer 130 includes, for example, a first recognizer 132 and a second recognizer 134. Details of these functions will be described later.

The action plan generator 140 generates an action plan for causing the vehicle M to travel by automated driving based on the recognition result of the recognizer 130 and the like. For example, the action plan generator 140 travels in the recommended lane determined by the recommended lane determiner 61 in principle, and further generates a target trajectory that the vehicle M will automatically (without depending on the operation of the driver) travel in the future so as to be able to respond to the surrounding situation of the vehicle M, based on the recognition result by the recognizer 130 and the surrounding road shape based on the current position of the vehicle M acquired from the map information. The target trajectory includes, for example, a speed element. For example, the target trajectory is expressed as a sequence of points (trajectory points) that the vehicle M should reach. A trajectory point is a point that the vehicle M should reach for each predetermined travel distance (for example, about several [m]) in terms of distance along the road, and separately from that, a target speed and target acceleration for each predetermined sampling time (for example, about 0.X [sec]) are generated as part of the target trajectory. In addition, a trajectory point may be a position that the vehicle M should reach at the sampling time, for each predetermined sampling time. In this case, the information on the target speed and target acceleration is expressed by intervals between trajectory points.

The action plan generator 140 may set events for automated driving in generating the target trajectory. Events include, for example, a constant speed travel event corresponding to causing the vehicle M to travel in the same lane at a constant speed, a following travel event corresponding to ACC that causes the vehicle M to follow the other vehicle that exists within a predetermined distance ahead (for example, within 100 [m]) of the vehicle M and is closest to the vehicle M, a lane keeping travel event corresponding to LKAS that causes the vehicle M to travel in the center of the travel lane, a lane change event corresponding to ALC that causes the vehicle M to change lanes from the own lane to an adjacent lane, a branch event that causes the vehicle M to branch to a lane on the destination side at a road branch point, a merge event that causes the vehicle M to merge onto a main line at a merge point, a takeover event for terminating automated driving and switching to manual driving, and the like. In addition, the events may include, for example, an overtaking event that causes the vehicle M to temporarily change lanes to an adjacent lane, overtake a preceding vehicle in the adjacent lane, and then change lanes back to the original lane, an avoidance event that causes the vehicle M to perform at least one of braking and steering in order to avoid an obstacle existing ahead of the vehicle M, and the like.

In addition, the action plan generator 140 may change an event already determined for the current section to another event or set a new event for the current section, for example, according to the surrounding situation of the vehicle M recognized during travel of the vehicle M. In addition, the action plan generator 140 may change an event already set for the current section to another event or set a new event for the current section, according to an operation of an occupant on the HMI 30. The action plan generator 140 generates a target trajectory according to the set event.

In addition, the action plan generator 140 includes, for example, a comparator 142, a driving controller 144, and a corrector 146. Details of these functions will be described later.

The second controller 160 controls the traveling driving force output device 200, the brake device 210, and the steering device 220 so that the vehicle M passes through the target trajectory generated by the action plan generator 140 at the scheduled time.

The second controller 160 includes, for example, a target trajectory acquirer 162, a speed controller 164, and a steering controller 166. The target trajectory acquirer 162 acquires information on the target trajectory (trajectory points) generated by the action plan generator 140 and stores it in a memory (not shown). The speed controller 164 controls the traveling driving force output device 200 or the brake device 210 based on a speed element associated with the target trajectory stored in the memory. The steering controller 166 controls the steering device 220 according to the degree of bending of the target trajectory stored in the memory. The processing of the speed controller 164 and the steering controller 166 is realized, for example, by a combination of feedforward control and feedback control. As an example, the steering controller 166 executes a combination of feedforward control according to the curvature of the road ahead of the vehicle M and feedback control based on deviation from the target trajectory.

Returning to FIG. 1, the HMI controller 180 notifies occupants of predetermined information by the HMI 30. The predetermined information includes, for example, information related to travel of the vehicle M, such as information related to the state of the vehicle M and information related to driving control. Information related to the state of the vehicle M includes, for example, the speed of the vehicle M, engine rotation speed, shift position, and the like. In addition, information related to driving control includes, for example, the presence or absence of execution of driving control by automated driving, information for inquiring whether or not to start automated driving, information related to the driving control situation by automated driving, information related to driving mode, information that prompts an occupant to drive when switching from automated driving to manual driving, and the like. In addition, the predetermined information may include information related to the surrounding situation recognized by the detection device DD. In addition, the predetermined information may include information unrelated to travel of the vehicle M, such as TV programs, content (for example, movies) stored in a storage medium such as a DVD. In addition, the predetermined information may include, for example, information related to the current position and destination in automated driving, and the remaining amount of fuel of the vehicle M. The HMI controller 180 may output the information received by the HMI 30 to the communication device 20, the navigation device 50, the first controller 120, or the like.

In addition, the HMI controller 180 may cause the HMI 30 to output inquiry information to occupants, processing results by the first controller 120 and the second controller 160, and the like. In addition, the HMI controller 180 may transmit various information to be output to the HMI 30 to a terminal device used by an occupant of the vehicle M via the communication device 20.

The traveling driving force output device 200 outputs traveling driving force (torque) for the vehicle to travel to drive wheels. The traveling driving force output device 200 includes, for example, a combination of an internal combustion engine, an electric motor, a transmission, and the like, and an ECU (Electronic Controller) that controls these. The ECU controls the above configuration in accordance with information input from the second controller 160 or information input from the accelerator pedal of the driving operator 80.

The brake device 210 includes, for example, a brake caliper, a cylinder that transmits hydraulic pressure to the brake caliper, an electric motor that generates hydraulic pressure in the cylinder, and a brake ECU. The brake ECU controls the electric motor in accordance with information input from the second controller 160 or information input from the brake pedal of the driving operator 80, so that brake torque corresponding to the braking operation is output to each wheel. The brake device 210 may include, as a backup, a mechanism that transmits hydraulic pressure generated by operation of the brake pedal to the cylinder via a master cylinder. Note that the brake device 210 is not limited to the configuration described above, and may be an electronically controlled hydraulic brake device that controls an actuator in accordance with information input from the second controller 160 to transmit the hydraulic pressure of the master cylinder to the cylinder.

The steering device 220 includes, for example, a steering ECU and an electric motor. The electric motor changes the direction of steered wheels by applying force to, for example, a rack and pinion mechanism. The steering ECU drives the electric motor in accordance with information input from the second controller 160 or information input from the steering wheel of the driving operator 80, to change the direction of the steered wheels.

### Recognizer and action plan generator

Next, details of driving control of the vehicle M based on the functions of the recognizer 130 (mainly the first recognizer 132 and the second recognizer 134) and the action plan generator 140 (mainly the comparator 142, the driving controller 144, and the corrector 146) will be described.

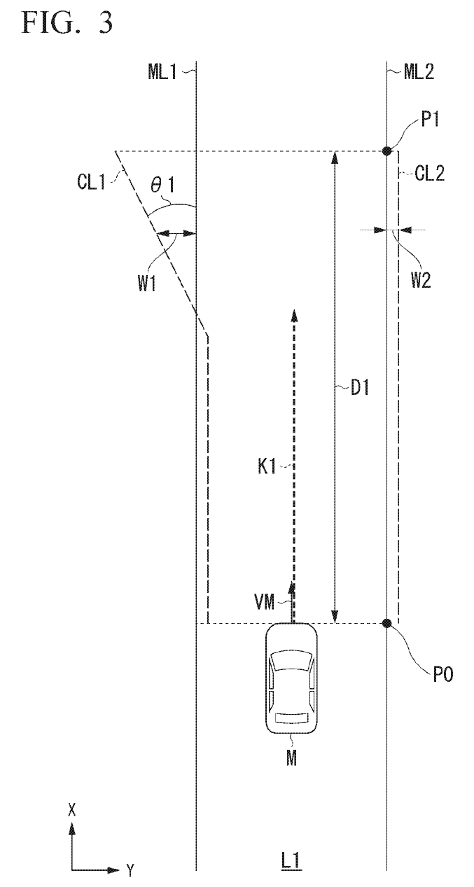

FIG. 3 is a diagram for explaining driving control of the vehicle M according to the embodiment. In the example of FIG. 3, device marking lines CL1 and CL2 recognized by the detection device DD and map marking lines ML1 and ML2 obtained from map information (for example, the second map information 62) based on position information of the vehicle M are shown. For example, in the map information, a lane L1 is delineated by the map marking lines ML1 and ML2. The lane L1 shown in FIG. 3 is a lane that can proceed in an extending direction (X-axis direction in the figure), and is a road shape in which a degree of bending is less than a threshold value. Hereinafter, when the device marking lines CL1 and CL2 are not distinguished from each other, they may be simply referred to as "device marking lines CL", and when the map marking lines ML1 and ML2 are not distinguished from each other, they may be simply referred to as "map marking lines ML". In addition, in the first scene shown in FIG. 3, the vehicle M is traveling on the lane L1 at a speed VM. In addition, as necessary, the lane L1 on which the vehicle M travels may be referred to as "travel lane L1" (the same applies to the lane L2 to be described later).

In the example of FIG. 3, the first recognizer 132 recognizes the surrounding situation of the vehicle M based on the output of the detection device DD that has detected the surrounding situation (external world) of the vehicle M. For example, the first recognizer 132 recognizes, as device marking lines CL1 and CL2, the left and right marking lines as viewed from the vehicle M that delineate the travel lane (lane L1) of the vehicle M, based on an image captured by the camera 10 (hereinafter, camera image). In the example of FIG. 3, the device marking lines CL1 and CL2 ahead of the vehicle M are shown, but the device marking lines CL1 and CL2 on the sides and rear may also be recognized.

For example, the first recognizer 132 analyzes the camera image, extracts edge points where the luminance difference with adjacent pixels is large in the image, and connects the edge points to recognize the device marking lines CL1 and CL2 in the image plane. In addition, the first recognizer 132 converts the positions of the device marking lines CL1 and CL2 based on the position of the representative point of the vehicle M into a vehicle coordinate system (for example, the XY plane coordinates in FIG. 3).

In addition, the first recognizer 132 may recognize, for example, the curvature of the device marking lines CL1 and CL2. In addition, the first recognizer 132 may recognize the amount of change in curvature of the device marking lines CL1 and CL2. In addition, the first recognizer 132 may average the curvature or amount of change in curvature of each of the device marking lines CL1 and CL2 to recognize the curvature or amount of change in curvature of the lane delineated by the device marking lines CL1 and CL2. The device marking lines CL1 and CL2 may be recognized or corrected based on the output of a detection device (for example, the radar device 12 or the LIDAR 14) other than the camera 10.

The second recognizer 134 recognizes, for example, marking lines of lanes in the surroundings of the vehicle M from map information based on the position of the vehicle M detected by the vehicle sensor 40 or the GNSS receiver 51. For example, the second recognizer 134 refers to the map information based on the position information of the vehicle M, and recognizes the left and right marking lines of the vehicle M that delineate the travel lane L1 of the vehicle M as map marking lines ML1 and ML2.

In addition, the second recognizer 134 may recognize the curvature or amount of change in curvature of each of the map marking lines ML1 and ML2 from the second map information 62. In addition, the second recognizer 134 may average the curvature or amount of change in curvature of each of the map marking lines ML1 and ML2 to recognize the curvature or amount of change in curvature of the travel lane L1.

The comparator 142 compares the device marking line CL recognized by the first recognizer 132 and the map marking line ML recognized by the second recognizer 134. For example, the comparator 142 performs a left marking line comparison that compares the device marking line CL1 and the map marking line ML1 that delineate the left side of the travel lane L1, and a right marking line comparison that compares the device marking line CL2 and the map marking line ML2 that delineate the right side of the travel lane L1, in a section (comparison target range) from the current position of the vehicle M (point P0 in the figure) to a position (point P1 in the figure) separated by a distance (comparison target distance) D1 in the traveling direction (ahead). Here, the distance D1 may be, for example, a distance to the farthest point of the device marking lines CL1 and CL2 that can be recognized by the detection device DD by the first recognizer 132, or may be a fixed distance.

For example, as a comparison of the left marking line in the comparison target range based on the distance D1 (determination range, monitoring range), the comparator 142 performs comparison of at least one of the position, extending direction (angle), curvature, and amount of change in curvature of the device marking line CL1 and the map marking line ML1. For example, the comparator 142 superimposes the device marking line CL1 and the map marking line ML1 on a plane (XY plane) of the vehicle coordinate system based on the position of the representative point of the vehicle M, compares the lateral positions (lane width direction, Y-axis direction in the figure) of the device marking line CL1 and the map marking line ML1, and acquires a deviation amount W1. The deviation amount W1 may be the maximum amount of deviation in the comparison target range, or may be an average.

In addition, the comparator 142 may compare the extending directions of the device marking line CL1 and the map marking line ML1, and acquire a deviation angle θ1 of the marking line. The deviation angle θ1 may be the maximum angle of deviation in the comparison target range, or may be an average. In addition, the comparator 142 may compare the curvature or amount of change in curvature of the device marking line CL1 and the map marking line ML1, and acquire the degree (magnitude) of the difference. Then, the comparator 142 may acquire the degree of divergence based on the deviation amount W1, the deviation angle θ1, and the degree of difference in curvature or amount of change in curvature. In this case, the degree of divergence becomes larger as the deviation amount W1 becomes larger, as the deviation angle θ1 becomes larger, and as the degree of difference in curvature (amount of change in curvature) becomes larger.

In addition, similarly to the comparison of the left marking line, the comparator 142 performs comparison of at least one of the position (deviation amount W2 in the figure), deviation angle, curvature, and amount of change in curvature of the device marking line CL2 and the map marking line ML2 as a comparison of the right marking line in the comparison target range, and acquires the degree of divergence. In addition, the comparator 142 may acquire the degree of divergence between the device marking line CL and the map marking line ML by integrating the comparison result of the left marking line and the comparison result of the right marking line.

The driving controller 144 performs control (driving control) of the vehicle M based on the recognition results of the first recognizer 132 and the second recognizer 134, the comparison result by the comparator 142, and the like. For example, the driving controller 144 determines driving control for the vehicle M based on the above recognition results, comparison results, and the like, and generates a target trajectory based on the determined driving control. "Determining driving control" may include, for example, determining the content (type) of driving control and determining whether or not to execute driving control (suppress it). In addition, "executing driving control" may include, in addition to switching and executing the content of driving control, continuing driving control that is already being executed. "Suppressing driving control" may include not only not executing driving control, but also lowering the mode (automation level) of driving control.

Here, the driving control includes a first driving mode and a second driving mode in which a degree of driving assistance is lower than the first driving mode, or a task of an occupant of the vehicle M is greater than the first driving mode. A lower degree of driving assistance means, for example, that the automation rate in driving control is low. A low automation rate means, for example, that the degree to which the automated driving control device 100 controls the steering or speed of the vehicle M is low (the degree of necessity for the driver to intervene in steering or acceleration/deceleration operations is high). A greater task of the occupant means, for example, that the number of tasks imposed on the occupant is large or the tasks are severe. Tasks are, for example, monitoring the surroundings of the vehicle M, an occupant operating the driving operator 80, and the like. Operation of the driving operator 80 includes, for example, the driver being in a state of gripping the steering wheel (hereinafter, hands-on state). Note that the driving control may include a third driving mode in which the degree of driving assistance is lower than the second driving mode, or the task of the occupant of the vehicle M is greater than the second driving mode. In addition, the driving mode with the lowest degree of driving assistance or the greatest task of the occupant of the vehicle M may be a completely manual driving mode (a mode in which driving control is not executed).

For example, in the first driving mode, the occupant has no task (or the task is the lightest), and driving control (for example, ACC, LKAS, ALC, TJP, CMBS, or the like) is permitted in a state in which the occupant of the vehicle M is not gripping the steering wheel (hereinafter, hands-off state). In addition, in the second driving mode, the task imposed on the occupant may include, for example, monitoring the surroundings of the vehicle M and being in a hands-on state.

For example, during execution of the first driving mode (for example, driving control in a hands-off state), when, as a result of comparison of the left marking line and comparison of the right marking line in the comparison target range, the degrees of divergence of both marking lines are both less than a threshold value, the driving controller 144 continues the first driving mode. For example, when the driving controller 144 is executing LKAS that travels in the center of the travel lane L1 as the first driving mode, based on the device marking lines CL1 and CL2 or the map marking lines ML1 and ML2, the driving controller 144 generates a target trajectory for traveling in the center of the travel lane L1, and causes the second controller 160 to execute control so as to travel along the generated target trajectory K1.

Note that in the embodiment, when the degrees of divergence of both marking lines are both less than the threshold value, the corrector 146 may correct the position of the map marking line ML at a stage before the target trajectory K1 is generated by the driving controller 144. In this case, the corrector 146 may correct the position of the map marking line ML so as to match the position of the device marking line CL in a section from the current position of the vehicle M (point P0) to a position (point P1) separated by a distance D1 in the traveling direction. Position correction may be, for example, correction of the deviation amount in the lateral direction (lane width direction) of the marking line, correction of the deviation angle, or correction of the curvature or amount of change in curvature. In addition, correcting so as to match means correcting so that the positions of the left and right marking lines are aligned (overlapping), and correcting so that the degree of divergence is within a tolerance range smaller than the threshold value. In addition, the corrector 146 may perform correction for each of the map marking lines ML1 and ML2, may correct the position (lateral deviation or angle deviation) of the lane L1, or may correct the position of the entire map information. The driving controller 144 can generate a more appropriate target trajectory K1 by using the corrected map marking lines ML1 and ML2, and more appropriate driving control can be realized using this target trajectory K1.

In addition, during execution of the second driving mode, when the degree of divergence of the marking lines in the comparison target range is less than the threshold value, the driving controller 144 may perform control to switch from the second driving mode to the first driving mode. In this case, when performing switching control, the driving controller 144 may cause the HMI 30 to output information that switching is possible or information that inquires whether or not to switch (or information that proposes switching) to the occupant, and may switch the driving mode when information indicating permission for switching is received from the occupant. In addition, the driving controller 144 may switch from the second driving mode to the first driving mode at the timing when the degree of divergence of the left and right marking lines becomes less than the threshold value, after an instruction to switch to the first driving mode is given by the HMI 30.

In addition, when the degree of divergence of the marking lines in the comparison target range is equal to or greater than the threshold value, the driving controller 144 may suppress driving control by the first driving mode. For example, during execution of the first driving mode, when the degree of divergence of the marking lines in the comparison target range is equal to or greater than the threshold value, the driving controller 144 executes driving control to switch from the first driving mode to the second driving mode. This can further improve safety.

Note that when only one of the left and right degrees of divergence is equal to or greater than the threshold value and the other degree of divergence is less than the threshold value, the driving controller 144 may set a marking line on the other side at a position offset by the same distance to the other side based on the distance in the lateral direction (lane width direction) between the marking line on the other side and the vehicle M, and continue the first driving mode. This can continue the hands-off state and improve the continuity of driving control. In addition, during execution of the second driving mode, when the degree of divergence of the marking lines in the comparison target range is equal to or greater than the threshold value, the driving controller 144 may perform control so as not to be able to execute switching to the first driving mode.

Here, when a road shape (hereinafter referred to as "S-curve road") exists in the lane (road) on which the vehicle M travels in which the road bends to the other of the left and right after bending to one of the left and right as viewed from the vehicle M, the detection accuracy of the device marking line CL decreases ahead of the inflection point (the point where bending to the other of the left and right begins after bending to one of the left and right) of the S-curve road, and as a result, if comparison of marking lines is performed by the comparator 142 in a section (comparison target range) ahead of the inflection point, the accuracy decreases. This is more influenced by the difficulty of approximating marking lines to a polynomial on an S-curve road than by the problem of the accuracy of the detection device such as the camera 10, and due to this influence, the accuracy becomes low, and the degree of divergence becomes large in matching of marking lines near the inflection point. Therefore, the possibility of the driving mode being switched near the inflection point becomes high. In particular, in the case of a slight S-curve road, since an occupant of the vehicle M judges it to be a road close to a straight line, a situation arises in which it is not understood why the driving mode is switched from the first driving mode (for example, hands-off state) to the second driving mode (hands-on state). Therefore, in the present embodiment, when a road shape having an inflection point exists in the travel lane of the vehicle M, the comparator 142 adjusts the distance (comparison target distance) D1.

Note that the comparator 142 detects, for example, the inflection point (the position where the inflection point is located) based on a change in the extending direction of the map marking line obtained from the map information. Specifically, the comparator 142 uses the distribution of the direction (map yaw [rad]) of the map marking line (or travel lane) obtained from the map information, and detects a point where the changing direction of the direction changes as an inflection point. In the embodiment, the comparator 142 may detect the inflection point based on curvature information included in the map information, but since there are cases where the accuracy of the curvature included in the map information is not very high, and also in the case of a slight S-curve road, the inflection point can be detected with good accuracy from the change in the extending direction, it is preferable to detect the inflection point based on the change in the extending direction of the map marking line ML. This can detect the inflection point or S-curve road with good accuracy. In addition, the comparator 142 may recognize the inflection point based on the recognition result by the first recognizer 132.

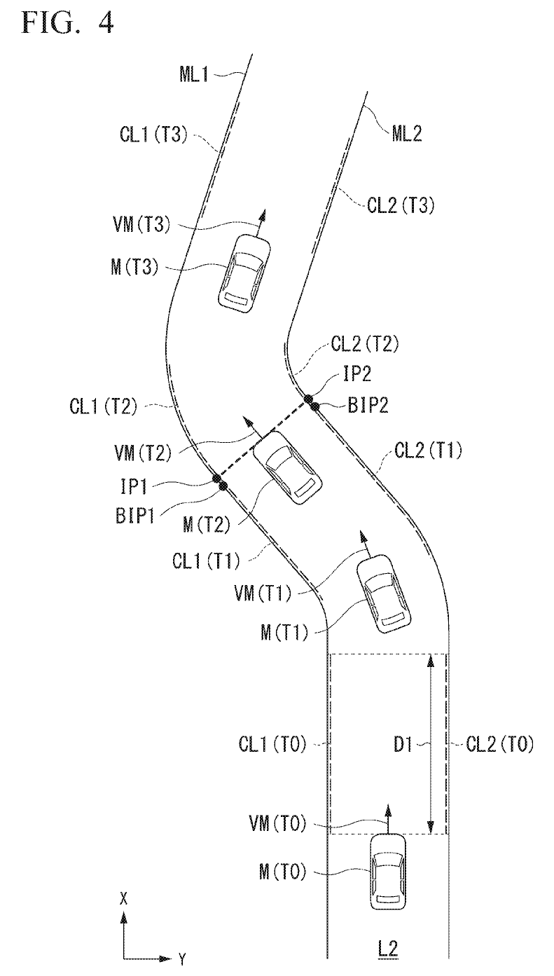

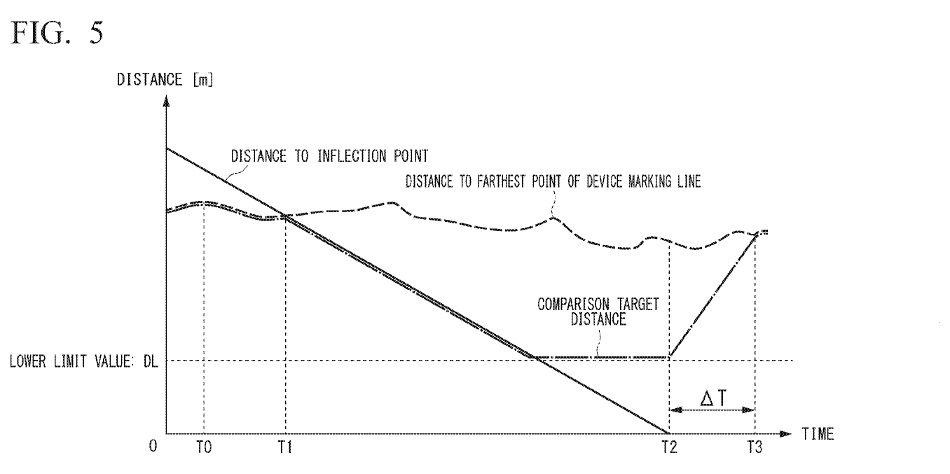

FIG. 4 is a diagram for explaining driving control in a road shape including an inflection point. FIG. 5 is a diagram for explaining a manner of change in the distance D1 based on the distance between the vehicle M and the inflection point.

In the example of FIG. 4, a state is shown in which the vehicle M travels at a speed VM on a travel lane L2 including a road shape that bends to the right after bending to the left as viewed from the vehicle M. Note that in FIG. 4, an inflection point IP1 of the map marking line ML1 and an inflection point IP2 of the map marking line ML2 are shown. On the road, the point connecting the inflection points IP1 and IP2 by a straight line is the inflection point. Hereinafter, the inflection point on the road may be referred to as "inflection point IP". In FIG. 4, the position and speed of the vehicle M at time T* are expressed as M(T*) and VM(T*). In addition, the device marking lines CL1 and CL2 recognized by the first recognizer 132 at time T* are expressed as CL1(T*) and CL2(T*). In the example of FIG. 4, time T0 is the earliest, and times T1, T2, and T3 become later in that order.

In addition, in the example of FIG. 5, the horizontal axis indicates time, and the vertical axis indicates distance [m]. In the example of FIG. 5, the relationship between the distance to the inflection point IP when the vehicle M moves at a predetermined speed VM, the distance to the farthest point of the device marking line CL, and the comparison target distance (distance D1) to be adjusted is shown. Note that in the example of FIG. 5, the distance to the farthest point of the device marking line CL changes with time (time), but this is due to, for example, changes in the surrounding road shape, the influence of disturbances such as sunlight and street lights, and the like.

For example, at time T0, ahead (in the traveling direction) as viewed from the vehicle M(T0), the map marking lines ML1 and ML2 extend along the X-axis direction in the figure, and the inflection point IP does not exist in a section from the position of the vehicle M(T0) to the farthest point of the device marking line CL that can be detected by the detection device DD. Therefore, at time T0, the comparator 142 sets the distance D1 as the distance from the position of the vehicle M(T0) to the farthest point of the device marking line CL that can be detected by the detection device DD. Then, the comparator 142 performs comparison between the device marking line CL1(T0) and the map marking line ML1, and between the device marking line CL2(T0) and the map marking line ML2, in the comparison target range up to the distance D1. In addition, the driving controller 144 executes driving control based on the comparison result. At this time, the corrector 146 may perform correction to align the position of the map marking line ML with the position of the device marking line CL based on the comparison result.

In addition, when the inflection point IP exists in the travel lane L2 in the traveling direction of the vehicle M, the comparator 142 performs comparison based on marking lines up to a point on the vehicle M side from the inflection point IP. Time T1 indicates a point in time when the vehicle M(T1) approaches the inflection point IP (or the road shape having the inflection point IP), and the farthest point of the device marking line CL that can be detected by the detection device DD becomes the inflection point IP (in FIG. 4, the point where bending to the right begins after bending to the left). At this point in time, the comparator 142 shortens (makes shorter) the distance D1 before the inflection point IP is included in the comparison target range.

Specifically, the comparator 142 sets the distance D1 as a distance up to points BP1 and BP2 that are a predetermined distance (several [m]) closer (on the vehicle M side) than the inflection points IP1 and IP2, as shown in FIG. 4, so that the inflection point is not included in the comparison target range. Then, the comparator 142 performs comparison between the device marking lines CL1(T1) and CL2(T2) and the map marking lines ML1 and ML2 in the comparison target range up to the set distance D1. This can perform marking line comparison without including the inflection point IP (or a section ahead of the inflection point), so that the influence of accuracy degradation when approximating marking lines to a polynomial on an S-curve road can be mitigated. In addition, as a secondary effect of the above processing, the processing load can be reduced, and comparison of marking lines can be performed more appropriately. In addition, since the degree of divergence can be made less likely to be equal to or greater than the threshold value, the continuity of driving control can be improved.

Furthermore, from after time T1 until time T2 when the vehicle M reaches the inflection point, the comparator 142 shortens the distance D1 as the vehicle M approaches the inflection point IP so that the distance D1 becomes shorter than the distance from the vehicle M to the inflection point IP (in other words, so that the inflection point IP or a section ahead of the inflection point IP is not included in the comparison target range). For example, the comparator 142 sets the distance D1 from the vehicle M as the distance from the current position of the vehicle M to the points BP1 and BP2.

However, if the comparison target range is adjusted by adjusting the distance D1 as described above, when approaching too close to the inflection point, the comparison target range becomes too short, and appropriate comparison of marking lines cannot be performed, and there is a possibility that driving control based on the comparison result cannot be executed appropriately. Therefore, as shown in FIG. 5, the comparator 142 may set a lower limit value DL for the distance D1 and adjust it so that the distance D1 does not become smaller than the lower limit value DL. The lower limit value DL may be, for example, a value at which the accuracy of the comparison result is predicted to be equal to or greater than a threshold value according to the surrounding situation, may be a value at which the first driving mode is predicted to be able to continue, or may be a fixed value.

Note that when performing comparison of marking lines in a comparison target range based on the lower limit value DL, although the comparison is in a section including the inflection point IP, since the comparison target range is a short range, it is possible to suppress the degree of divergence from becoming large. Therefore, comparison of marking lines can be performed more appropriately while maintaining the safety of driving control.

Time T2 is the time when the vehicle M(T2) reaches the position of the inflection point IP. At this point in time, the comparator 142 performs comparison between the device marking lines CL1(T2) and CL2(T2) and the map marking lines ML1 and ML2 based on the lower limit value DL described above. In addition, after time T2 (after the vehicle M passes the inflection point IP), the comparator 142 adjusts the distance D1 so that the comparison target distance returns to the original distance (that is, returns to the distance to the farthest point of the device marking line CL). Note that if the distance D1 is instantaneously returned to the original distance, there is a possibility that the comparison accuracy (degree of divergence) will change greatly due to a sudden change in the comparison target range. Therefore, as shown in FIG. 5, the comparator 142 can perform comparison of marking lines more appropriately by gradually increasing the distance D1 and returning it to the original distance, and the continuity of driving control can be improved. Note that, as shown in FIG. 5, the comparator 142 may adjust so as to gradually return to the original distance by the time a predetermined time ΔT elapses from time T2. In addition, the comparator 142 may gradually adjust with a change amount (increase amount) according to the distance separating from the inflection point IP, corresponding to a change amount (decrease amount) decreased according to the distance to the inflection point IP when approaching the inflection point IP, until the original distance is reached.

In addition, at time T3, the distance D1 becomes the distance from the position of the vehicle M(T3) to the farthest point of the device marking line CL that can be detected by the detection device DD (returns to the original distance). The comparator 142 performs comparison between the device marking lines CL1(T3) and CL2(T3) and the map marking lines ML1 and ML2 in the comparison target range up to the distance D1. In addition, the driving controller 144 executes driving control based on the comparison result.

Note that the comparator 142 may include, as a condition for performing the adjustment of the distance D1 described above, a case where the degree of bending (for example, curvature) of the marking line (device marking line CL, map marking line ML) or travel lane is less than a predetermined value. This can improve the continuity of driving control on an S-curve road or the like that is close to a straight line (or gentle), and can reduce the discomfort of occupants caused by switching of driving control. In addition, since it is possible to suppress continuation of driving control too much on a road with a degree of bending equal to or greater than a predetermined value, safety can be further improved.

In addition, in the embodiment, when the device marking line CL (information on the travel lane of the vehicle M) cannot be recognized due to the surrounding situation (for example, wear of marking lines, reflection of sunlight, or the like) in a predetermined range, the first recognizer 132 may suspend recognition of the device marking line CL. However, when the degree of bending (for example, curvature) of the marking line (for example, the map marking line ML) is less than a predetermined value, the first recognizer 132 may not suspend recognition of the device marking line CL even when the device marking line CL cannot be recognized. This can improve the continuity of driving control (first driving mode) by continuing recognition by the first recognizer 132 even though the degree of divergence of marking lines is large.

In addition, when the device marking line CL (information on the travel lane of the vehicle M) cannot be recognized by the first recognizer 132 due to the influence of the surrounding situation or the like, and the degree of bending of the marking line (for example, the map marking line ML) is less than a predetermined value, the comparator 142 may not perform comparison between the device marking line CL and the map marking line ML until a predetermined time elapses. In the case of a gentle S-curve road in which the degree of bending is less than the predetermined value, even if the device marking line CL cannot be recognized temporarily, it is possible to travel by continuing the target trajectory up to immediately before. Therefore, the continuity of driving control can be improved by not performing comparison.

### Processing Flow

Hereinafter, processing executed by the automated driving control device 100 according to the embodiment will be described. In the following, among the processing executed by the automated driving control device 100, mainly driving control processing based on recognition results of marking lines and the like will be described. The processing shown below may be repeatedly executed at predetermined timing or at predetermined cycles.

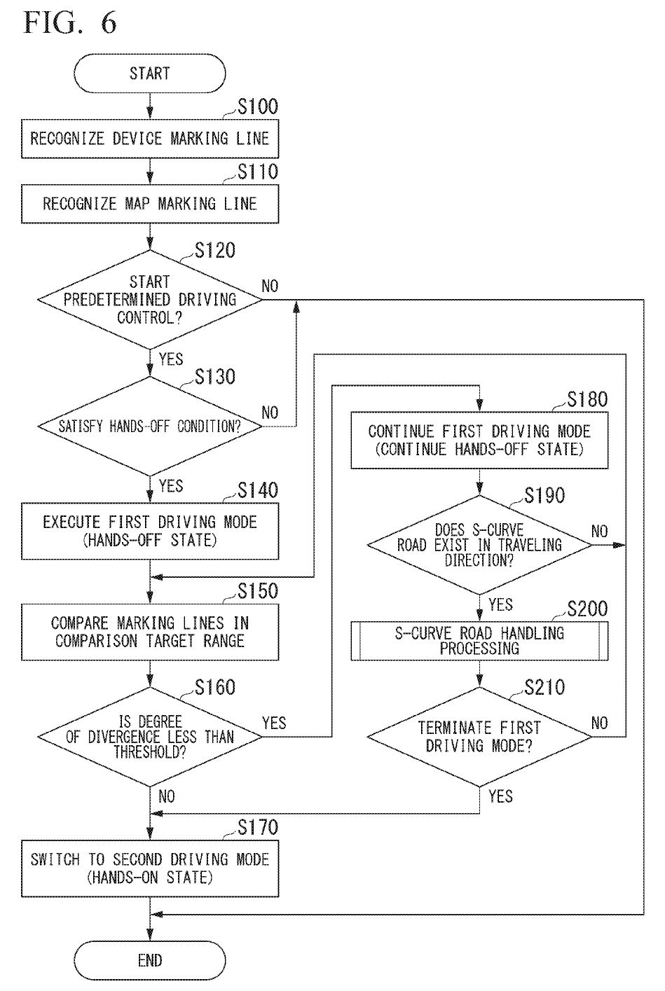

FIG. 6 is a flowchart showing an example of a flow of driving control processing in the embodiment. In the example of FIG. 6, the first recognizer 132 recognizes the surrounding situation including marking lines (device marking line CL) existing in the surroundings of the vehicle M, based on the output of the detection device DD that has detected the surrounding situation of the vehicle M (step S100). Next, the second recognizer 134 refers to the map information based on the position information of the vehicle M, and recognizes marking lines (map marking line ML) existing in the surroundings of the vehicle M from the map information (step S110).

Next, the driving controller 144 determines whether or not to start predetermined driving control (step S120). The predetermined driving control is driving control in which the steering, speed, and the like of the vehicle M are controlled based on recognized marking lines, and includes, for example, ACC, LKAS, and the like. The start of the predetermined driving control may be, for example, when an execution instruction for the predetermined driving control is received by an operation of the HMI 30 by an occupant of the vehicle M, or may be when the surrounding situation recognized by the first recognizer 132 satisfies a start condition for the predetermined driving control. When it is determined that the predetermined driving control is to be started, the driving controller 144 determines whether or not a hands-off condition is satisfied (step S130). The hands-off condition is a condition for executing driving control (first driving mode) in a hands-off state, and includes, for example, in the case of LKAS, that left and right marking lines are recognized, that a time to collision TTC with surrounding obstacles (other vehicles, etc.) is equal to or greater than a predetermined time, and the like, but is not limited to these. Note that the time to collision TTC is derived, for example, by dividing a relative distance by a relative speed in the relationship between the vehicle M and an obstacle.

When it is determined that the hands-off condition is satisfied, the driving controller 144 starts the first driving mode in which a hands-off state is possible (step S140). In the processing of step S140, for example, when executing LKAS as the first driving mode, the driving controller 144 generates a target trajectory for the vehicle M to pass through the center of the travel lane delineated by the recognized left and right device marking lines CL or map marking lines ML, and causes the second controller 160 to execute steering control and speed control of the vehicle M so that the vehicle M travels along the generated target trajectory.

Next, the comparator 142 compares marking lines (device marking line CL and map marking line ML) existing on each of the left and right of the vehicle M in a comparison target range based on a distance (comparison target distance) D1 set according to the road situation (step S150), and determines whether or not the degree of divergence is less than a threshold value (step S160). When it is determined that the degree of divergence is not less than the threshold value, the driving controller 144 performs control to switch from the first driving mode to the second driving mode in which a hands-on state is entered (step S170).

In addition, in the processing of step S160, when it is determined that the degree of divergence is less than the threshold value, the driving controller 144 continues the driving control of the first driving mode (hands-off state) (step S180). In addition, the comparator 142 determines whether or not an S-curve road exists in the traveling direction (ahead) of the vehicle M (step S190). When it is determined that an S-curve road exists in the traveling direction, the action plan generator 140 executes S-curve road handling processing (step S200). Details of the processing of step S200 will be described later.

After the processing of step S200, the driving controller 144 determines whether or not to terminate the first driving mode, based on the result of the S-curve road handling processing (step S210). When it is determined that the first driving mode is to be terminated, the processing of step S170 is performed, and when it is determined that the first driving mode is not to be terminated, the processing returns to step S150. In addition, also in the processing of step S190, when it is determined that an S-curve road does not exist in the traveling direction, the processing returns to step S150. This terminates the processing of the present flowchart. In addition, in the processing of step S120, when it is determined that the predetermined driving control is not to be started, or in the processing of step S130, when it is determined that the hands-off condition is not satisfied, the processing of the present flowchart is terminated.

### Step S200: S-curve Road Handling Processing

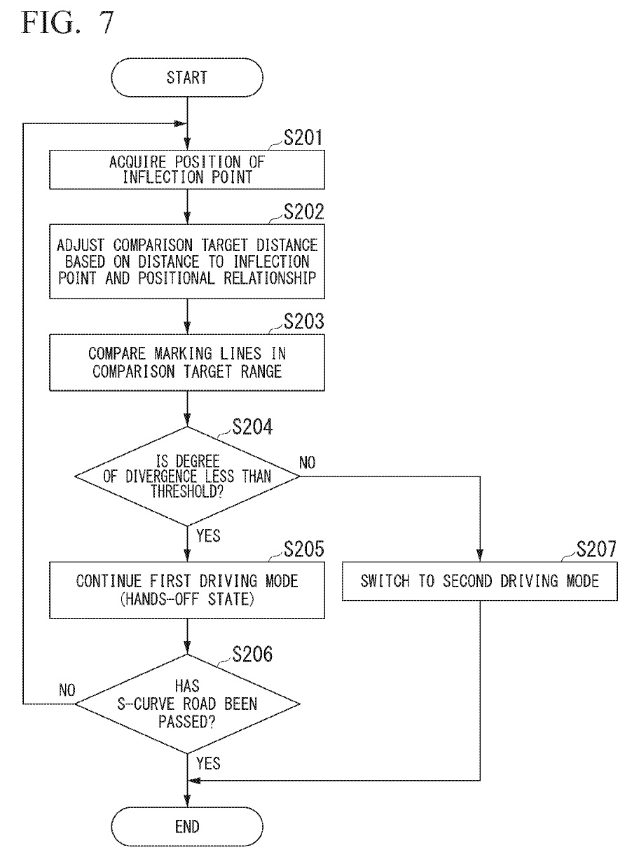

FIG. 7 is a flowchart showing an example of S-curve road handling processing. The example of FIG. 7 is a specific example of the processing of step S200 described above. In the example of FIG. 7, the comparator 142 acquires the position of the inflection point IP (step S201). Next, the comparator 142 adjusts a distance (comparison target distance) that is a reference for a comparison target range in which the device marking line CL and the map marking line ML are compared, based on the distance to the inflection point IP and the positional relationship (for example, whether the vehicle M is approaching the inflection point IP or is separating from the inflection point IP) (step S202). For example, in the processing of step S202, the comparator 142 adjusts the comparison target distance based on the relationship between the distance to the inflection point IP and the distance to the farthest point of the device marking line CL, as shown in FIG. 5.

Next, the comparator 142 compares the device marking line CL and the map marking line ML in the comparison target range based on the comparison target distance (step S203), and determines whether or not the degree of divergence is less than a threshold value (step S204). When it is determined that the degree of divergence is less than the threshold value, the driving controller 144 continues the first driving mode (step S205). Next, the comparator 142 determines whether or not the S-curve road has been passed (step S206). When it is determined that the S-curve road has not been passed, the processing returns to step S201, and when it is determined that the S-curve road has been passed, the processing of the present flowchart is terminated. In addition, in the processing of step S204, when it is determined that the degree of divergence is not less than the threshold value, the driving controller 144 switches to the second driving mode (turns on a flag for switching) (step S207). This terminates the processing of the present flowchart.

Note that in the processing of step S160 or the processing of step S204 described above, when it is determined that the degree of divergence is less than the threshold value, the corrector 146 may perform correction to align the map marking line ML with the device marking line CL.

### Modified Example

In the embodiment described above, when a plurality of inflection points exist in the traveling direction of the vehicle M, the control to adjust the distance D1 described above is performed based on the nearest inflection point. In addition, when inflection points IP exist in both the front and rear of the vehicle M, adjustment of the distance D1 is performed with priority given to the inflection point IP ahead. This can perform appropriate control for the inflection point that has the greatest influence on comparison of marking lines or driving control, and as a result, the continuity of driving control can be improved.

In addition, the HMI controller 180 may generate information indicating the comparison result by the comparator 142 described above and cause the HMI 30 to output it, and in that case, may generate information indicating that the distance (comparison target distance) D1 is being adjusted near the inflection point, and cause the HMI 30 to output it. This can make an occupant grasp the situation of comparison of marking lines more accurately.

As described above, according to the embodiment described above, in the automated driving control device 100 (an example of a vehicle control device), the first recognizer 132 that recognizes, as a device marking line, a marking line that delineates a travel lane of the vehicle M, based on an output of a detection device that detects a surrounding situation of the vehicle M, the second recognizer 134 that recognizes, as a map marking line, a marking line that delineates the travel lane of the vehicle M from map information, based on position information of the vehicle M, the comparator 142 that compares the device marking line and the map marking line based on recognition results of the first recognizer 132 and the second recognizer 134, and the driving controller 144 that controls the vehicle M based on a comparison result by the comparator 142, are provided, and the comparator 142 performs comparison based on marking lines up to a point on the vehicle M side from a point where bending to the other of the left and right begins, when a road shape exists in the travel lane in the traveling direction of the vehicle M in which the road bends to the other of the left and right after bending to one of the left and right as viewed from the vehicle M, whereby comparison of road marking lines can be performed more appropriately according to road conditions. Furthermore, this can contribute to the development of sustainable transportation systems.

According to the embodiment, marking lines that are farther than the inflection point that cannot be expressed by a cubic curve of the device marking line can be excluded from the comparison target range with the map marking line, and by performing comparison of marking lines in a section closer than the inflection point, comparison of marking lines can be performed more appropriately. In addition, by performing comparison in a range that does not include the inflection point, it is possible to suppress the degree of divergence from becoming equal to or greater than the threshold value, so that the continuity of driving control such as the first driving mode can be improved.

The embodiment described above can be expressed as follows.

A vehicle control device including:

a storage medium storing computer-readable instructions; and

a processor connected to the storage medium,

wherein the processor executing the computer-readable instructions to:

recognize, as a device marking line, a marking line that delineates a travel lane of a vehicle, based on an output of a detection device that detects a surrounding situation of the vehicle;

recognize, as a map marking line, a marking line that delineates the travel lane of the vehicle from map information, based on position information of the vehicle;

compare the recognized device marking line and the map marking line;

control the vehicle based on a result of the comparison; and

perform the comparison based on marking lines up to a point on the vehicle side from a point where bending to the other of the left and right begins, when a road shape that bends to the other of the left and right after bending to one of the left and right as viewed from the vehicle exists in the travel lane in the traveling direction of the vehicle.

Although the embodiments for carrying out the present invention have been described above using embodiments, the present invention is not limited to such embodiments in any way, and various modifications and substitutions can be made within a range that does not depart from the scope of the present invention.

What is claimed is:

1. A vehicle control device comprising:
a memory storing a instructions; and
a processor configured to execute the instructions stored in the memory to:
recognize, as a device marking line, a marking line that delineates a travel lane of a vehicle, based on an output of a detection device that detects a surrounding situation of the vehicle;
recognize, as a map marking line, a marking line that delineates the travel lane of the vehicle from map information, based on position information of the vehicle;
compare the device marking line and the map marking line based on recognition results; and
control the vehicle based on a comparison result of the comparator, wherein
when a road shape that bends to the other of the left and right after bending to one of the left and right as viewed from the vehicle exists in the travel lane in the traveling direction of the vehicle, the processor performs the comparison based on marking lines up to a point on the vehicle side from a point where bending to the other of the left and right begins.

2. The vehicle control device according to claim 1, wherein the processor:
performs the comparison in a range based on a comparison target distance ahead of the vehicle in the traveling direction; and
shortens the comparison target distance before the point where bending to the other of the left and right begins exists within the comparison target distance from the vehicle, as the vehicle approaches the road shape.

3. The vehicle control device according to claim 2, wherein
the processor shortens the comparison target distance as the vehicle approaches the point where bending to the other of the left and right begins, such that the comparison target distance becomes shorter than a distance from a position of the vehicle to the point where bending to the other of the left and right begins.

4. The vehicle control device according to claim 2, wherein
the processor gradually returns the comparison target distance to the distance before shortening, after the vehicle passes the point where bending to the other of the left and right begins.

5. The vehicle control device according to claim 1, wherein
the road shape is a road shape in which a degree of bending of the travel lane is less than a threshold value, and which bends to the other of the left and right after bending to one of the left and right as viewed from the vehicle.

6. The vehicle control device according to claim 5, wherein the processor:
suspends recognition of the device marking line when information of the travel lane cannot be acquired; and
does not suspend recognition of the device marking line even when information of the travel lane cannot be acquired, when the vehicle travels on the road shape in which the degree of bending of the travel lane is less than the threshold value.

7. The vehicle control device according to claim 1, wherein
the processor detects the point where bending to the other of the left and right begins, based on a change in an extending direction of the map marking line.

8. The vehicle control device according to claim 1, wherein
the control of the vehicle includes driving control by a first driving mode and a second driving mode in which a degree of driving assistance is lower than in the first driving mode or an occupant of the vehicle has more tasks than in the first driving mode, and
the processor continues the driving control by the first driving mode when driving control by the first driving mode is being executed and a degree of divergence between the device marking line and the map marking line is less than a threshold value.

9. The vehicle control device according to claim 1, wherein the processor further executes instructions to:
correct the map marking line based on the device marking line,
wherein the processor performs the correction when a degree of divergence between the device marking line and the map marking line is less than a threshold value, and
the processor controls the vehicle based on the corrected map marking line.

10. The vehicle control device according to claim 1, wherein
the control of the vehicle includes driving control by a first driving mode and a second driving mode in which a degree of driving assistance is lower than the first driving mode or a task of an occupant of the vehicle is greater than the first driving mode, and
the processor switches the control of the vehicle from the first driving mode to the second driving mode when driving control by the first driving mode is being executed and a degree of divergence between the device marking line and the map marking line is equal to or greater than a threshold value.

11. A vehicle control method in which a computer:
recognizes, as a device marking line, a marking line that delineates a travel lane of a vehicle, based on an output of a detection device that detects a surrounding situation of the vehicle;
recognizes, as a map marking line, a marking line that delineates the travel lane of the vehicle from map information, based on position information of the vehicle;
compares the recognized device marking line and the map marking line;
controls the vehicle based on a result of the comparison; and
when a road shape that bends to the other of the left and right after bending to one of the left and right as viewed from the vehicle exists in the travel lane in the traveling direction of the vehicle, performs the comparison based on marking lines up to a point on the vehicle side from a point where bending to the other of the left and right begins.

12. A computer-readable non-transitory storage medium storing a program that causes a computer to:
recognize, as a device marking line, a marking line that delineates a travel lane of a vehicle, based on an output of a detection device that detects a surrounding situation of the vehicle;
recognize, as a map marking line, a marking line that delineates the travel lane of the vehicle from map information, based on position information of the vehicle;
compare the recognized device marking line and the map marking line;
control the vehicle based on a result of the comparison; and
when a road shape that bends to the other of the left and right after bending to one of the left and right as viewed from the vehicle exists in the travel lane in the traveling direction of the vehicle, perform the comparison based on marking lines up to a point on the vehicle side from a point where bending to the other of the left and right begins.
